(19) United States
(12) Patent Application Publication
(10) Pub. No.: US 2009/0325578 A1
(43) Pub. Date: Dec. 31, 2009

(54) SUPPORT FOR MULTI-GROUP FREQUENCY DIVISION DUPLEX WIRELESS NETWORK

(75) Inventors: Zexian Li, Espoo (FI); Aik Chindapol, Princeton, NJ (US); Roberto Albanese, Helsinki (FI); Andrea Bacioccola, Helsinki (FI)

Correspondence Address: BRAKE HUGHES BELLERMANN LLP, c/o CPA Global, P.O. BOX 52050, MINNEAPOLIS, MN, 55402, US

(73) Assignee: Nokia Siemens Networks Oy, Espoo (FI)

(21) Appl. No.: 12/163,084

(22) Filed: Jun. 27, 2008

(51) Int. Cl. H04W 36/00

(52) U.S. Cl. 455/436

(57) ABSTRACT

Various example embodiments are disclosed herein. According to an example embodiment, a method may include receiving, at a serving base station (BS) in a wireless network from a mobile station (MS), group preference information for the MS for each of one or more candidate BSs; obtaining, by the serving BS based on the group preference information, a group assignment for the MS from each of the one or more candidate BSs; and sending by the serving BS to the MS the group assignment from each of the candidate BSs.

### TECHNICAL FIELD

This description relates to wireless networks.

### BACKGROUND

In some types of wireless networks, a Map may typically be used to allocate uplink (UL) and/or downlink (DL) resources to mobile stations (MSs) (or subscriber stations). For example, a Map Information Element (Map IE) may be sent by a base station (BS) or other infrastructure node that specifies a location (e.g., symbol offset) and length of the resource allocation that is assigned to a MS or connection for a same frame or a subsequent frame (or subframe or superframe). In this manner, a BS may transmit a Map IE to allocate a burst or group of symbols to a MS for a frame. If resources are to be allocated for multiple frames, then the BS would typically transmit a Map IE for each frame for which resources will be allocated.

In some types of wireless networks, mobile stations (MSs) may be divided up into two groups (for example) to provide a more efficient use of channel resources, so that a base station (BS) may allocate the uplink carrier frequency and the downlink carrier frequency resources to different groups at a time, or in an alternating or interleaved fashion, to allow half-duplex (HD) MSs to use both the uplink and downlink resources. However, challenges remain in determining how to allocate or assign MSs to groups, and in determining how to assign or allocate a MS to a group when a handover is performed for the MS from a serving BS to a new (or target) BS.

### SUMMARY

According to an example embodiment, a method may include receiving, at a serving base station (BS) in a wireless network from a mobile station (MS), group preference information for the MS for each of one or more candidate BSs; obtaining, by the serving BS based on the group preference information, a group assignment for the MS from each of the one or more candidate BSs; and sending by the serving BS to the MS the group assignment from each of the candidate BSs.

According to another example embodiment, a method may include receiving at a serving base station (BS) from a mobile station (MS) in a wireless network a first message including information identifying a requested or preferred group for the MS to join for each of the one or more candidate BSs; sending a handover request message from the serving BS to each of the one or more candidate BSs, each handover request message including the information identifying a requested or preferred group for the MS to join for the candidate BS; receiving, from each of the one or more candidate BSs, a handover response message including at least a group assignment for the MS; sending, from the serving BS to the MS, a second message including the group assignment for each of the one or more candidate BSs; receiving, from the MS, a handover indication message identifying a group and a selected one of the one or more candidate BSs for handover; and, sending a handover confirm message to the selected one of the one or more candidate BSs confirming that a handover will be performed for the MS with the selected candidate BS.

According to another example embodiment, a method may include receiving at a serving base station (BS) from a mobile station (MS) in a wireless network a first message including a Map decode capability indication (Map DCI) for each of one or more group Maps, the one or more Map DCIs being provided with respect to each of one or more candidate base stations (BSs); sending a handover request message, including at least the Map DCI for each of one or more group Maps and an address of the MS, to each of the one or more candidate BSs; receiving, from each of the one or more candidate BSs, a handover response message including at least a group assignment for the MS; sending, from the serving BS to the MS, a second message including the group assignment for each of the one or more candidate BSs; receiving, from the MS, a handover indication message identifying a group and a selected one of the one or more candidate BSs for handover; and sending a handover confirm message to the selected one of the one or more candidate BSs confirming that a handover will be performed for the MS with the selected candidate BS.

According to an example embodiment, an apparatus may include a controller, and a wireless transceiver. The apparatus may be configured to: receive at a serving base station (BS) from a mobile station (MS) in a wireless network a first message including a Map decode capability indication (Map DCI) for each of one or more group Maps, the one or more Map DCIs being provided with respect to each of one or more candidate base stations (BSs); send a handover request message, including at least the Map DCI for each of one or more group Maps and an address of the MS, to each of the one or more candidate BSs; receive, from each of the one or more candidate BSs, a handover response message including at least a group assignment for the MS; send, from the serving BS to the MS, a second message including the group assignment for each of the one or more candidate BSs; receive, from the MS, a handover indication message identifying a group and a selected one of the one or more candidate BSs for handover; and send a handover confirm message to the selected one of the one or more candidate BSs confirming that a handover will be performed for the MS with the selected candidate BS.

According to another example embodiment, a method may include sending, from the MS to a serving base station (BS), group preference information for the MS for each of one or more candidate BSs; receiving by the MS from the serving BS a group assignment from each of the one or more candidate BSs; selecting one of the candidate BSs for handover for the MS; and sending, from the MS to the serving BS, a handover indication message identifying the selected candidate BS. Alternatively, the MS may select one of the one or more groups and one of the candidate BSs for handover for the MS; and may send, to the serving BS, a handover indication message identifying the selected candidate BS and selected (or preferred or proposed) group.

According to another example embodiment, a method may include determining by a mobile station (MS) in a wireless network, that the MS is capable of decoding one or more group Maps for each of one or more candidate BSs; sending, from the MS to a serving base station (BS), a Map decode capability indication (Map DCI) for each of one or more group Maps, the one or more Map DCIs being provided with respect to each of one or more candidate base stations (BSs); receiving by the MS from the serving BS a group assignment from each of the one or more candidate BSs; selecting one of the candidate BSs for handover for the MS; and sending, from the MS to the serving BS, a handover indication message identifying the selected candidate BS for handover. According to another example embodiment, a method may include determining by a mobile station (MS) in a wireless network, that the MS is capable of decoding one or more group Maps for each of one or more candidate BSs; performing, by the MS, ranging with each of the one or more of the candidate BSs to negotiate a proposed group that the MS may join with the candidate BS; and sending a mobile station handover (MSHO) request message to a serving base station (BS) in the wireless network.

According to another example embodiment, a method may include decoding by a mobile station (MS) in a wireless network, one or more group Maps transmitted from each of one or more candidate Base Stations (BSs); sending, from the MS to a serving base station (BS), a mobile station handover (MSHO) request message identifying one or more of the candidate BSs; receiving at the MS from the serving BS, a base station handover response message identifying one or more of the candidate BSs; selecting one of the candidate BSs for handover for the MS; sending, from the MS to the serving BS, a handover indication message identifying the selected candidate BS; and performing ranging by the MS with the selected candidate BS, including indicating to the candidate BS a proposed or preferred group for the MS to join. According to yet another example embodiment, a method may include determining by a mobile station (MS) in a wireless network, that a MS is capable or not of decoding one or more group Maps transmitted from a serving BS, and sending, from the MS to the serving base station (BS), a Map decode capability indication (Map DCI) for each of the one or more group Maps transmitted by the serving BS.

According to yet another example embodiment, a method may include receiving, at a serving base station (BS) from a mobile station (MS), a Map decode capability indication (Map DCI) for each of one or more group Maps transmitted by the serving BS, determining an updated group assignment for the MS based on the receiving, and sending a message from the serving BS to the MS identifying the updated group assignment for the MS.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a diagram illustrating an example embodiment of a frame that may be used according to an example embodiment.

FIG. 3 is a timing diagram illustrating operation of a system according to an example embodiment.

FIG. 4 is a timing diagram illustrating operation of a system according to another example embodiment.

FIG. 5 is a timing diagram illustrating operation of a system according to yet another example embodiment.

FIG. 6 is a flow chart illustrating operation of a serving base station according to an example embodiment.

FIG. 7 is a flow chart illustrating operation of a serving base station according to another example embodiment.

FIG. 8 is a flow chart illustrating operation of a serving base station according to another example embodiment.

FIG. 9 is a flow chart illustrating operation of a mobile station according to another example embodiment.

FIG. 10 is a flow chart illustrating operation of a mobile station according to another example embodiment.

FIG. 11 is a flow chart illustrating operation of a mobile station according to another example embodiment.

FIG. 12 is a flow chart illustrating operation of a mobile station according to yet another example embodiment.

FIG. 13 is a flow chart illustrating operation of a mobile station according to yet another example embodiment.

FIG. 14 is a flow chart illustrating operation of a base station according to yet another example embodiment.

FIG. 15 is a block diagram of a wireless node according to an example embodiment.

### DETAILED DESCRIPTION

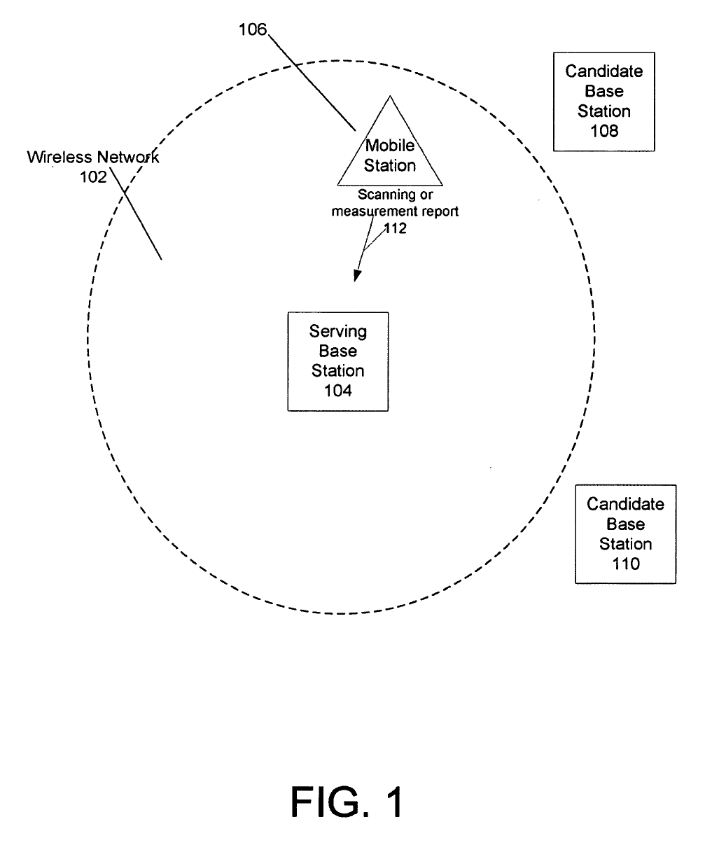

FIG. 1 is a block diagram of a wireless network 102 including a base station 104 and a mobile station (MS) 106 according to an example embodiment. Although not shown, MS 106 may be coupled to base station 104 via relay stations or relay nodes, for example. Two additional base stations (BSs) are shown, including a candidate BS 108 and a candidate BS 110. Also, while only one MS is shown in network 102, any number of MSs may be provided within network 102. The wireless network 102 may include, for example, an IEEE 802.16 Worldwide Interoperability for Microwave Access (WiMAX) network, an IEEE 802.11 Wireless Local Area Network (WLAN), or a cellular telephone network, according to example embodiments. The base station 104 may include a cellular or WiMAX base station (BS), a node B, an 802.11 access point, or other infrastructure node, according to various example embodiments. The term “base station” (BS) may be used herein and may include any type of infrastructure node. The mobile station 106 may include a laptop or notebook computers, smartphones, personal digital assistants (PDAs), cellular telephones, WiMAX device, subscriber station, or any other wireless device, according to example embodiments. The term “wireless node” may include any type of wireless node, such as base stations, mobile stations, etc. While the present disclosure may use some of the terminology of WiMAX or other wireless standards, the aspects of the present disclosure may be applicable to any networking or wireless technologies.

A handover of MS 106 may be performed from a serving BS 104 to one of several possible or candidate BSs, e.g., candidate BSs 108, 110, . . . . Avery brief overview of the handover procedure will be described, according to an example embodiment. Not all the details are included, but only a very brief summary of some details. The handover procedure may be considered as divided into three steps (or phases), as an example: 1) handover preparation, e.g., which may include signal measurements, scanning, ranging; 2) handover decision (e.g., deciding or determining to perform a handover, and/or selecting a candidate BS for handover), which may be performed based on metrics, measurements, scanning, algorithms, etc., at the BS and/or MS. In an example embodiment, the decision phase may be considered part of the preparation phase. and 3) handover execution (e.g., which may include the signaling phase of sending/originating or receiving messages from MS or from BS (depending on who has the control of the process). Some aspects of these 3 phases will be briefly described, according to an example embodiment.

The handover preparation may be initiated by either the MS or the BS. During handover preparation, for example, neighbor (or candidate) BSs may typically be compared by one or more metrics, such as received signal strength, Quality of Service (QoS) parameters, and one of the candidate BSs is selected. The MS may, in some cases, perform ranging with the selected candidate BS to expedite the future handover. The MS may request handover by sending to the serving BS a mobile station handover (MSHO) request message, to which the serving base station may reply with a base station handover (BSHO) response message that may identify one or more candidate BSs. Alternatively, the MS may scan for signals transmitted by neighbor BSs, and may generate and send to the serving BS a mobile scanning (or measurement) report 112 of neighboring BSs (e.g., reporting one or more metrics or values for each of the neighboring BSs). The serving BS 104 may trigger handover with a BSHO request message, e.g., which may include a list of suggested candidate BSs that MS can handover to.

After handover preparation, handover execution may start. For example, when the MS is about to move to the new link (to the new BS) after selecting one of the candidate BSs, the MS may send a handover indication message to the serving BS. After making a new attachment with the new or selected candidate BS, the MS may perform ranging with the selected candidate (or target) BS to acquire physical parameters from the selected candidate BS, tuning its physical parameters to the target BS, and may negotiate basic capabilities such as maximum transmit power and modulator/demodulator type. The MS may then register with the new or target BS, and the new or target BS may begin serving the MS.

According to an example embodiment, mobile stations in a frequency-division duplex (FDD) wireless network may, for example, be divided up into two (or more) groups (for example) to provide a more efficient use of channel resources, so that a base station (BS) may allocate the uplink carrier frequency and the downlink carrier frequency resources to different groups at a time, or in an alternating or interleaved fashion, to allow HD (half-duplex) MSs to use both the uplink and downlink resources. Two groups (e.g., group 1 and group 2) are described herein as an example, but any number of groups may be used. For example, during one time period, a first group (or group 1 of HD MSs) of mobile stations may receive in a downlink direction, while a second group (group 2 of HD MSs) of mobile stations is allowed to transmit in an uplink direction to the BS or infrastructure node. Then, during a second time period, the first group may transmit and the second group may receive. Thus, Frequency Division Duplexing may be used to provide different uplink and downlink carrier frequencies or resources, which may allow some MSs to transmit, while other MSs are receiving, for example.

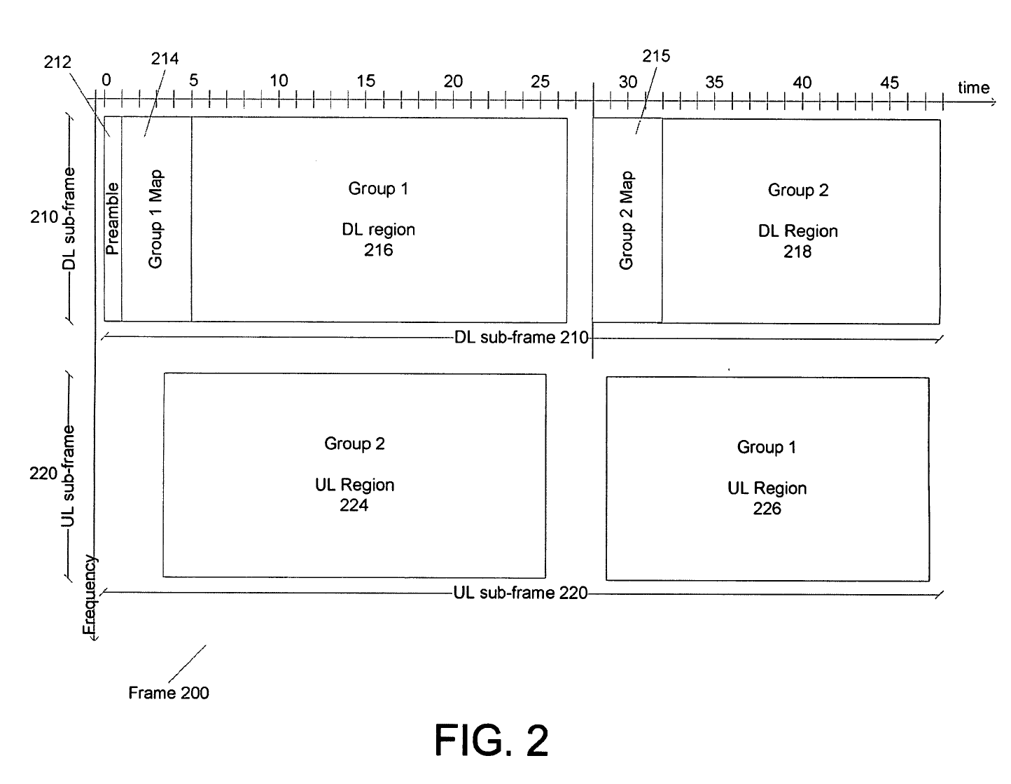

FIG. 2 is a diagram illustrating an example embodiment of a frame. The example frame 200 may include a DL (downlink) subframe 210 that includes signals transmitted from a base station and received at one or more mobile stations. Frame 200 may include an UL (uplink) subframe 220 that includes signals transmitted from one or more mobile stations and received by a base station. The frame 200 illustrates an example of a FDD system in which one or more mobile stations may receive DL signals via a first frequency (e.g., f1), or first set of frequencies, within a DL subframe 210, and may transmit signals UL to a base station via a second frequency (e.g., f2), or second set of frequencies, within an UL subframe 220. Other types of frames may be used as well, as the frame 200 is merely an example.

The DL subframe 210 may include a common preamble 212, since preamble 212 is directed to all groups (e.g., directed to mobile stations for both group 1 and group 2). The preamble 212 may allow mobile stations to perform synchronization. A group-specific Map may be provided for each DL region of frame 200. For example, a group 1 DL region 216 may include a group 1 Map 214, while a group 2 DL region 218 may include a group 2 Map 215. Each Map may include a DL Map and an UL Map, each including information elements identifying resources for downlink and uplink transmissions for one or more mobile stations. Each Map (e.g., Maps 214 and Map 215) may, for example, include Map IEs (information elements) that allocate resources for uplink and/or downlink transmissions for one or more mobile stations. The uplink (UL) subframe 220 may include resources (e.g., OFDM symbols) that allow mobile stations to transmit data to a base station.

The Maps may also provide the grouping information of mobile stations to different groups. The Maps may also include an indication for changing the mobile station from one zone/group to another zone/group.

The UL frame 220 may include at the beginning a switching period (TTG, or BS transmit/receive transition gap). The UL frame 220 may also include a group 2 UL region 224 to allow mobile stations of group 2 to transmit to the base station, and a group 1 UL region 226 to allow group 1 mobile stations to transmit to the base station. In some cases, Full-Duplex (FD) mobile stations (having the ability to transmit and receive on different frequencies at the same time) may receive data during either group 1 DL region 216 and/or group 2 DL region 218, and may transmit (or obtain resources for UL transmission) to the BS via either group 2 UL region 224 and/or group 1 UL region 226. In case of FD networks, the BS may allow FD MS (full-duplex mobile station) to transmit or receive data during the gaps (e.g., between groups' boundary). In another example embodiment, a BS may allow a FD MS to transmit at any time within a frame, e.g., via either group 2 UL region 224, and/or group 1 UL region 226 and/or even out of these group UL regions.

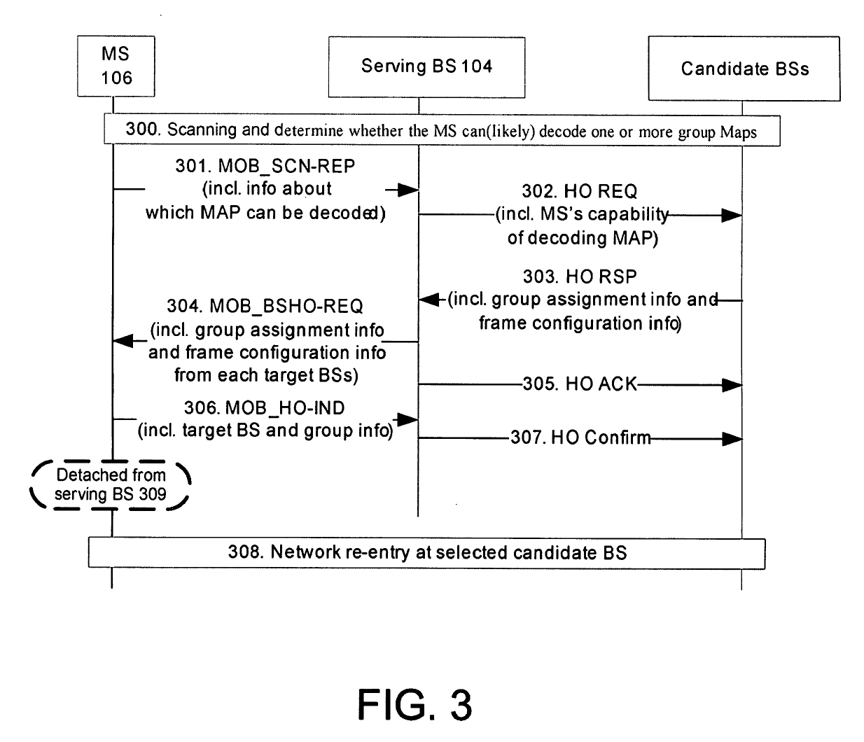

FIG. 3 is a timing diagram illustrating operation according to an example embodiment. A MS 106, a serving BS 104, and one or more candidate BSs (e.g., candidate BS 108, 110, . . . ) are shown in FIG. 3. Serving BS 104 may be currently serving multiple MSs including MS 106 within network 102 (FIG. 1), for example. At 300, MS 106 may perform scanning with one or more neighboring or candidate BSs, which may include, for example, receiving one or more group Maps (e.g., a group 1 Map and/or a group 2 Map) transmitted from each of the one or more candidate BSs, and determining whether the MS can decode one or group Maps from one or more candidate BSs (which may include decoding or attempting to decode a Map, measuring signal quality or signal strength of received signals or group Maps, or measuring signal statistics related to the received group Maps, or other processing), or choosing one or more of the group Maps to decode. A different modulation rate and coding scheme (MCS) may be used by a BS to transmit different group Maps. For example, BS 108 may transmit a group 1 Map, e.g., directed to MSs located relatively far away from the BS, using a first MCS that is relatively robust, and may transmit a group 2 Map, e.g., directed to MSs that may be closer, using a second MCS that is less robust (to provide greater transmission efficiency) than the MCS used for group 1 Map. This is merely an example. Thus, for example, a MS may, at least in some cases, be able to decode some group Maps, but may be unable to decode other group Maps. For example, a MS 106 may be able to decode a first group Map (e.g., a more robust MCS), but may be unable to decode a second group Map.

Each group Map may identify UL and DL resources, such as ranging resources for the group (that allow a MS to perform ranging with the BS as a member of that group). Thus, if a MS is unable to decode a group Map, the MS will not be able to obtain the ranging resources, and will be unable to perform ranging with that group, and will not know locations of UL and DL resources, etc. Thus, a MS may typically be unable to join or register as a member of a group with a BS if the MS is unable to decode the group Map for that group, according to an example embodiment. According to an example embodiment, decoding (signal decoding) may include signal acquisition, demodulating an acquired signal, performing a forward error correction and performing a CRC (cyclic redundancy check) check for a received packet or block of data. For example, the CRC check may include calculating a CRC over a packet (or portion thereof) and comparing (e.g., XORing) the calculated CRC to an appended CRC to confirm the two CRCs match, which may confirm that the packet was received without errors, for example. Other tasks may be included within signal decoding, as this merely describes an example of some tasks that may be included within signal decoding. In an example embodiment, at 300, the MS 106 may scan and determine whether the MS is capable of decoding one or more group Maps for each of one or more candidate BSs.

To determine whether or not the MS is capable of decoding one or more group Maps from each of the one or more candidate BSs, the MS may measure one or more signals from each candidate BS, or measure statistics related to signals received from each candidate BS, attempt to decode one or more group maps, etc. In an example embodiment, the MS may determine whether or not it can decode a group Map(s) from a candidate BS by, for example, by performing one or more of the following: acquiring a signal from a candidate BS; demodulating an acquired signal from a candidate BS; performing a forward error correction; performing a CRC (cyclic redundancy check) check on a packet received from a candidate BS; measuring a channel quality of a signal received from a candidate BS; or, measuring a channel quality of one or more group Maps received from a candidate BS.

For example, a MS may determine (or estimate) that it cannot (or will be unlikely to) decode a Map if the signal quality (e.g., received signal strength or RSSI or SINR) from a candidate BS is below a threshold, such as for a received group 1 Map or a group 2 Map from the candidate BS, or if the MS is unable to demodulate a packet or group Map from a BS, or a CRC check on a packet indicates an error, as examples. In one example embodiment, the MS may determine (or may estimate) that it is capable of decoding (or likely capable of decoding) one or group Maps from each candidate BS, e.g., if received signal strength or other channel quality indication indicates a strong signal for a received group Map, or is able to demodulate the group Map, or a portion thereof, the CRC check indicates no errors in a received signal or in a receive group Map from the candidate BS, etc. These are merely some examples of how a MS may determine that it is capable of decoding a group Map. Thus, because signal conditions are dynamic and may vary over time, and because this analysis may not necessarily fully decode a group Map, this analysis may only indicate decode capabilities in terms of probabilities or likelihoods, e.g., that the MS will likely be capable (or is likely incapable) of decoding a particular group Map, according to an example embodiment.

The MS 106, for example, may also determine a preferred group for each of the one or more candidate BSs. The preferred group may, for example, be the group corresponding to the only group Map that the MS can decode, or in the event the MS can decode both (or multiple) group Maps, the MS may select one of the two (or multiple) available groups as a preferred group to join, e.g., based on other criteria or metric or measurement, for example.

Although not required (and not shown in FIG. 3), during scanning at 300, the MS 106 may perform ranging with one or more of the candidate BSs, e.g., with one or more candidate BSs for which the MS is capable of decoding a group Map. Thus, the MS may also perform ranging with one or more of the candidate BSs, during scanning 300. For example, the MS may perform ranging with candidate BSs, S during scanning, e.g., for the MS to tune its physical parameters to the BS and negotiate basic capabilities such as power control which may expedite a future handover with the BS. The ranging may be performed using a ranging region(s) identified by one of the group Maps, for example. Thus, after decoding a group Map (and identifying ranging resources or a ranging region for the BS or for a specific group), the MS may perform ranging with the BS, e.g., to propose a group to the BS and/or to tune parameters and negotiate capabilities with the BS to expedite a possible handover. The MS may perform scanning and ranging with multiple neighbor BSs, since the MS may not know the selected or target BS to which handover may be performed.

The ranging may involve, for example, the MS sending a range request message to each candidate BS, where the range request may, for example, identify a proposed group for the MS to join. Rather than explicitly identifying a proposed or preferred group, if a group-specific ranging region is used for the ranging, this may implicitly indicate to the BS the proposed group for the MS. For example, by MS 106 performing initial ranging using a group 2 ranging region (resources allocated for group 2 ranging for this BS), this may indicate to the BS that the MS is proposing or requesting to join group 2. The candidate BS may reply with a range response either confirming the proposed group, or providing a different group for the MS to join, or providing an abort message or denial of the MS's request to join a specific group, and may identify a reason for the denial of the MS's request to join a group, such as the group is busy or full, or that the group has been reserved for other MSs or for other purpose, etc.

Referring to FIG. 3 again, after performing scanning and may determine whether it is capable (e.g., likely capable) of decoding one or more group Maps transmitted from one or more neighbor (or candidate) BSs, the MS 106 may send to the serving BS 104 a mobile scanning (or measurement) report (MOB_SCN-REP) 301 of the neighboring or candidate BSs. The mobile scanning report 301 may, for example, identify a preferred group (or group preference information) for each of the one or more candidate BSs, e.g., based on which group Maps the MS 106 can decode, or based on a response from a candidate BS during initial ranging, and/or based on other preferences of the MS for joining different groups. For example, the mobile scanning report 301 may include a preferred group indication (PGI) for each of the one or more candidate BSs, to identify one or more preferred groups. In another example embodiment, at 301, the MS 106 may send to the serving BS 104, either periodically or event triggered or upon request of the serving BS, the mobile scanning report, which may include at least a Map decode capability indication (Map DCI) for each of the one or more group Maps (e.g., for group 1 Map and/or group 2 Map) for each of the one or more candidate BSs. Thus, the Map DCI (which may be provided for one or more of the candidate BSs) may indicate which, if any, of the group Maps of the candidate BS, the MS is capable of decoding.

The MAP DCI may, for example, be in a form of a single value (or multiple values) indicating MAP decode ability, a time-series of MAP decode ability values, statistics of MAP decode ability or other information or format that aids the BS in determining the MS's ability to decode each MAP. A BS may use collective MAP DCIs from various MS(s) to determine an appropriate MCS for each MAP, for example. The Map DCI may be, for example, a bit map indicating 0 or 1 for each group Map (0 for likely cannot decode group Map, and 1 indicating likely can decode group Map). Each DCI value may provide a value within a range (e.g., 0 to 2) that indicates a highest decode capability for a group Map (e.g., signal acquisition, demodulation, or CRC check performed successfully). The Map DCIs may, in an example embodiment, simply provide signal quality information or signal statistics, such as identifying a received signal strength (RSSI) or SINR of a signal received from a candidate BS, and may even be a group Map specific channel quality indication (e.g., RSSI of a particular group Map), may be a value within a range that indicates a likelihood of being able to decode a group Map, or other value which may be used by the serving BS and/or candidate BS to assign or determine a group assignment for the MS (or to determine a suitable or suggested group assignment).

Next, the serving BS may consult with each of the one or more candidate BSs and obtain a group assignment for the MS. For example, the serving BS may send a handover request message (HO REQ) 302, including either preferred group information, such as PGI (preferred group indication identifying the MS's preferred group for this candidate BS) from the MS and/or information (e.g., Map DCI) indicating one or more group Maps that the MS is capable of decoding for the candidate BS (and/or identifying which group Maps the MS is unable to decode).

Next, the serving BS 104 may receive a handover response message (HO RSP) 303 from each of the one or more candidate BSs. The handover response message 303 may include, for example, a group assignment (which may be an actual group assignment or a proposed group assignment for the MS) for the MS for this BS and frame configuration information. The frame configuration may include, for example, group boundary information, a MCS (modulation and coding scheme) for the group, and a ranging opportunity (e.g., identifying ranging resources) for the assigned group (such as group 1 ranging resources), e.g., to allow the MS to perform ranging after handover to the selected candidate BS. The group boundary may, for example, identify a starting location of the group 2 Map 215, e.g., which may be provided as an offset from a reference location such as the beginning of a frame (see FIG. 2, for example). Next, in FIG. 3, the serving BS may send a BSHO request message (MOB_BSHO_REQ) 304 that includes the group assignment (received from each of the one or more candidate BSs) and possibly all or part of the frame configuration information. The serving BS 104 may then send a handover acknowledgement (HO ACK) 305 to each of the one or more candidate BSs. The MS 104 may select one of the candidate BSs for handover. The MS 104 may send a handover (HO) indication message (MOB_HO-IND) 306 to the serving BS 104, the HO indication message 306 identifying the selected candidate BS and a group. The group provided in handover indication message 306 may, for example, be the group assignment received from the selected candidate BS via BSHO request 304, or a group preferred or proposed by the MS, or may be the group corresponding to the group Map that can be decoded by the MS (of course, these may be the same group in some cases). Or in the event that ranging is performed by the MS with the selected candidate BS during scanning, the group identified in message 306 may be a group negotiated (or identified by the BS) during initial ranging.

The serving BS 104 may then send a handover confirmation message (HO Confirm) 307 to the selected candidate BS. For a soft handover, or a seamless handover, for example, the MS 106 may remain attached to the serving BS after handover, e.g., for at least some period of time. For example, for an IEEE 802.16-Rev2 seamless handover, the MS may (e.g., during handover) begin data exchange with the selected candidate BS before ranging (308) and even though the MS is not yet detached from serving BS. In another example embodiment, the MS 106 may then be detached 309 from the serving BS 104, and performs network entry 308 (or re-entry 308 if was previously performed by the MS 106 with the selected candidate BS, e.g., during scanning).

The diagram illustrated in FIG. 3 illustrates a BS initiated handover (BSHO request) 304, based on receipt of the mobile scanning report 301. Alternatively, the MS may initiate handover, e.g., by MS 106 sending a mobile station handover (MSHO) request message 301 (not shown), and the serving BS 104 replying with a BSHO response message. The MSHO request message 301 may include group information for each of the candidate BSs. For example, the MSHO request message 301 may identify a preferred group, such as by including a preferred group indication (PGI) for each of the one or more candidate BSs, and/or may include a Map decode capability indication (Map DCI) for each of the one or more group Maps. After consulting with each of the one or more candidate BSs, the serving BS may send the MS a BSHO response 304, which may include a group assignment for each of the one or more candidate BSs.

Thus, in the example embodiment, for example shown in FIG. 3, the serving BS 104 may obtain Map decode capability information (such as a Map DCI) and/or group preference information (such as PGI) from a MS for each candidate BS, and then may consult each BS, and then may provide (or forward) a group assignment to the MS for each candidate BS, e.g., based on the Map decode capability and/or the group preference information from the MS. For example, some of the group assignments provided to the MS may match the preferred group or the group that the MS is capable of decoding. However, it is possible, at least in one example embodiment, that the group assignment forwarded by the serving BS to the MS may be different from the preferred group and/or may not match a group that the MS can decode the Map. Thus, according to an example embodiment, the MS 106 and one or more candidate BSs may, via the serving BS 104, agree to a group (or determine a group that may be agreeable to both MS and BS, under whatever priority rules may control any conflict) before a handover to the candidate BS occurs. Thus, by determining this group assignment for the MS prior to handover, this may expedite the handover to the new or selected candidate BS, for example, since it may typically be unnecessary in such a case for the MS and selected candidate BS to negotiate the group assignment for the MS during ranging after handover.

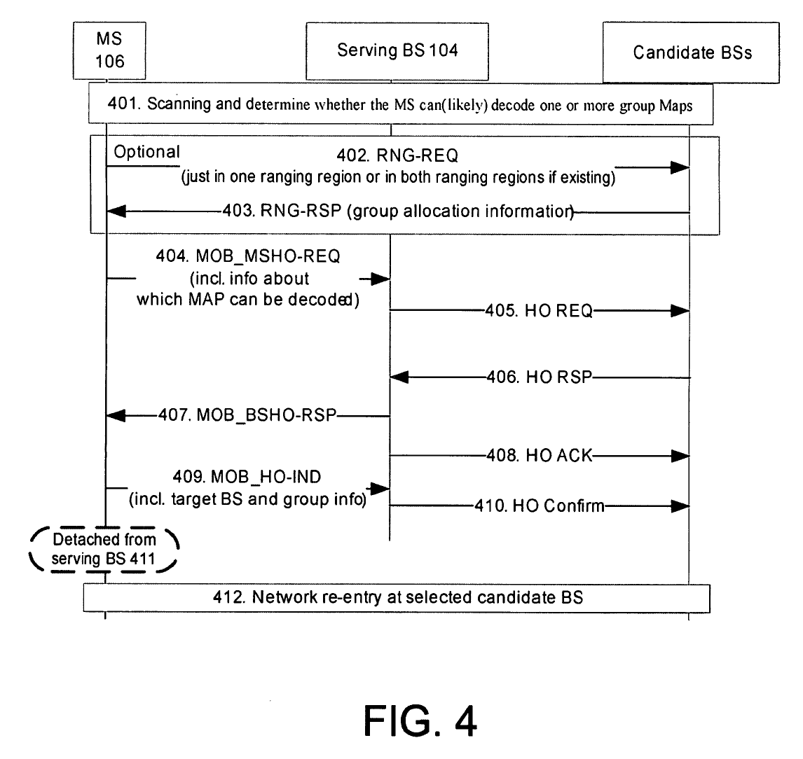

FIG. 4 is a timing diagram illustrating operation according to another example embodiment. In this example embodiment, the MS may typically perform ranging with one or more candidate BSs during or just after the scanning in order to directly negotiate with each of the one or more candidate BSs to determine a group assignment (or determine a preferred group) during the handover preparation phase. This may allow the MS to select a preferred group for each candidate BS, e.g., during or based on the initial ranging, which may occur during a scanning phase of the handover preparation phase.

At 401, the MS may scan received signals, e.g., preambles and Maps transmitted from neighbor BSs, and may determine (e.g., estimate) whether the MS can (likely) decode one or more group Maps from each of one or more candidate BSs.

During or, e.g., after the scanning phase 401, the MS may also perform ranging with each of the one or more candidate BSs, e.g., to determine a preferred group or obtain a group assignment for each candidate BS, for example. The ranging may include, for example, a range request 402 from the MS to the candidate BS, which may include Map decode capability information (such as a Map DCI) indicating which group Maps the MS can decode or not decode and/or group preference information (such as PGI). For example, if the MS is unable to decode group 2 Map for the BS, the MS may include this information (e.g., a Map DCI) within the ranging request 402 to the candidate BS, e.g., so that the BS can try to assign the MS to a group that can be decoded by the MS, or can try to accommodate the MS's group preference (e.g., if the preferred or requested group is not too loaded or has available resources). The MAP DCI may, for example, be in a form of a single value (or multiple values) indicating MAP decode ability (or an estimate of such decode ability), a time-series of MAP decode ability values, statistics of MAP decode ability or other information or format that aids the BS in determining or estimating the MS's likely ability to decode each MAP. A BS may use collective MAP DCIs from various MS(s) to determine an appropriate MCS for each MAP, for example.

The candidate BS may then determine an appropriate group for the MS to join, e.g., based on load for group 1 and group 2, the MS's ability to decode either or both group Maps, based on the MS's preference (if any indicated in the range request), and other information, for example. As part of the initial ranging, the BS may then reply to the range request 402 with a range response 403, which may typically include group information, such as a proposed group or a group assignment for the MS 106.

The MS 106 may then send a mobile station handover request message 404 to the serving BS 104. Although not required, the mobile station handover request may include, for example, Map decode capability information (such as a Map DCI) indicating which group Maps the MS can decode or not decode, or group preference information for the MS. Since the MS may have directly negotiated the group assignment (or group preference) with each candidate BS (e.g., via initial ranging), it may be unnecessary (at least in some cases) for the MS 106 to include the group information in the mobile station handover request message 404, for example.

The serving BS may send a handover request message 405 to each of the candidate BSs, and may receive a handover response message 406 from each BS. Although not required, message 405 may include the Map decode capability information (such as a Map DCI) indicating which group Maps the MS can decode or not decode, or group preference information for the MS. Serving BS 104 may then send a base station handover response message 407, which may identify one or more of the candidate BSs, as candidates for handover. The BS may send a handover acknowledgement 408 to each candidate BS. The MS 106 may select one of the candidate BSs for handover, and send a handover indication message 409, identifying the selected candidate BS and group information (e.g., group assignment or group preference). The serving BS may then send a handover confirm message 410, which may confirm that handover will be performed for the MS, and may include the group information. At 411, although not required, such as for soft handover, the MS may be detached from the serving BS 104, and the MS performs network re-entry (re-entry since the MS has already performed ranging with the selected BS). In an example embodiment, for soft handover, for example, the MS 106 may remain attached to the serving BS after handover, e.g., for at least some period of time, rather than being detached from the serving BS. Network re-entry 412 may be expedited since the MS and selected candidate BS may have already agreed on a group assignment for the MS, among other parameters, as part of the initial ranging.

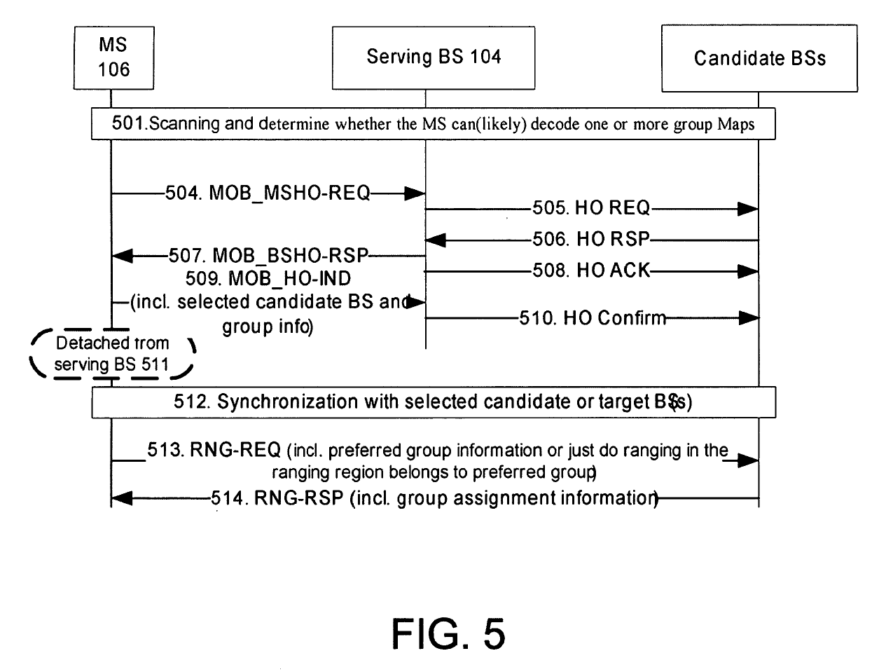

FIG. 5 is a timing diagram illustrating operation according to yet another example embodiment. The timing diagram illustrated in FIG. 5 is very similar to the diagram of FIG. 4, except the MS selects (or the MS and selected candidate BS negotiate) the group assignment during the ranging (operations 513 and 514) after handover has occurred. As a result, the messages (504, 505, 506, 507, 508, 509, 510) communicated during handover preparation do not typically include group preference information, group assignment information, or group map decode capability information, for example.

Referring to FIG. 5, the MS 106 may perform scanning 501 and may determine (e.g., estimate) whether the MS can (likely) decode one or more group Maps from each of one or more candidate BSs. The MS may send a mobile station handover request message 504 to the serving BS, to initiate a handover. The serving BS 104 may send a handover request 505 and receive a handover response 506 from each of the candidate BSs. The serving BS 104 may then select one of the candidate BSs, and then send a base station handover response message 507 to the MS 106, and the MS 106 may reply with a handover indication message 509 that identifies at least the selected candidate BS. The serving BS may also send a handover acknowledgement 508 to each candidate BS, and may send a handover confirm message 510 to the selected candidate BS. After the MS is detached (511) from the serving BS 104, the MS may perform network entry into the new or selected BS, as part of handover, including synchronization (512), or synchronizing with the selected candidate BS, and then performing ranging with the selected candidate BS. The ranging may include, for example, the MS sending a range request message 513 that includes group information, e.g., Map decode capability information (such as a Map DCI) indicating which group Maps the MS can decode or not decode, or group preference information for the MS. The MS may identify the preferred group (or the DCI or PGI) within the range request 513, or identify a preferred group by performing ranging within a group-specific ranging region (e.g., indicate a preference to join group 2 by performing ranging via a group 2 ranging region, which may have UL resources allocated for group 2 MSs to perform ranging with the BS, for example). The MAP DCI may, for example, be in a form of a single value (or multiple values) indicating MAP decode ability, a time-series (or time sequence) of MAP decode ability values, statistics of MAP decode ability or other information or format that aids the BS in determining the MS's ability to decode each MAP. A BS may use collective MAP DCIs from various MS(s) to determine an appropriate MCS for each MAP, for example.

In the event that the group (e.g., preferred group indication or PGI) provided by the MS (e.g., in message 306) is a group that is different from the group proposed or assigned by the MS, several different possibilities exist, including: 1) the BS's group assignment controls (e.g., limiting the MS's ability to select a group); 2) the MS may override the proposed group assignment from the BS, for example.

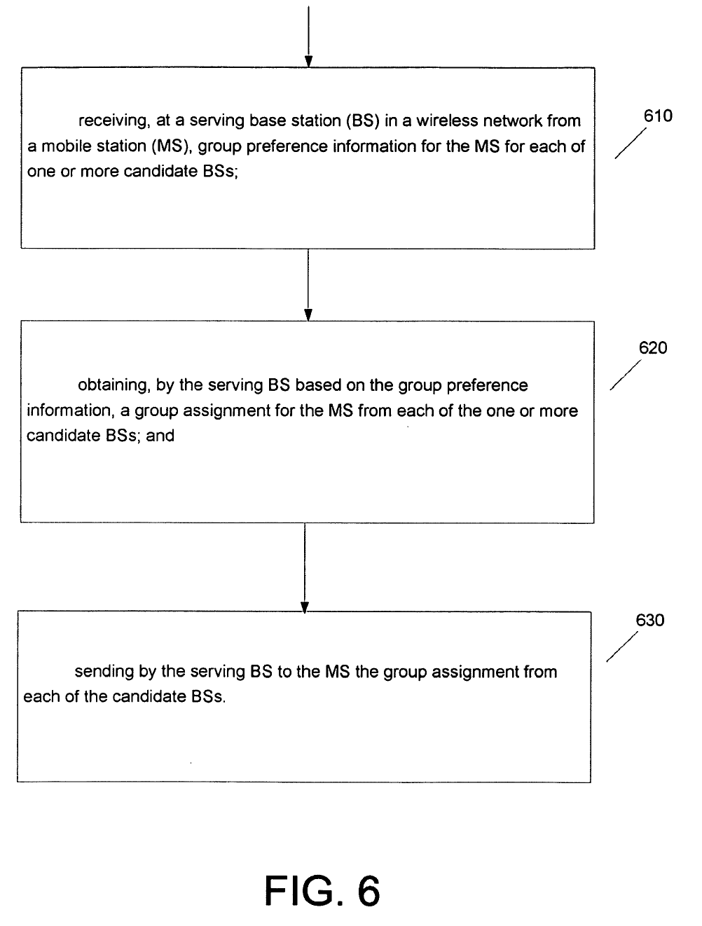

FIG. 6 is flow chart illustrating operation of a serving base station according to an example embodiment. Operation 610 may include receiving, at a serving base station (BS) in a wireless network from a mobile station (MS), group preference information for the MS for each of one or more candidate BSs. Operation 620 may include obtaining, by the serving BS based on the group preference information, a group assignment for the MS from each of the one or more candidate BSs. And, operation 630 may include sending by the serving BS to the MS the group assignment from each of the candidate BSs.

The flow chart illustrated in FIG. 6 may include additional operations including, for example, receiving, at the serving BS from the MS, a handover indication message identifying a selected candidate BS of the one or more candidate BSs for handover of the MS from the serving BS to the selected candidate BS.

Obtaining operation 620 may include, for example, obtaining, by the serving BS based on the group preference information, the group assignment for the MS and a group boundary from each of the one or more candidate BS, and wherein the sending operation 630 may include sending by the serving BS to the MS the group assignment and the group boundary from each of the candidate BSs.

The receiving operation 610 may include receiving from the MS a Map decode capability indication (Map DCI) for each of one or more group Maps, the one or more Map DCIs being provided with respect to each of one or more candidate base stations (BSs).

The receiving operation 610 may include receiving from the MS a preferred group indication (PGI) for one or more of the candidate BSs, the PGI identifying at least one of a group 1 or a group 2 as a preferred group of the MS to join of the candidate BS.

The obtaining operation 620 may include sending a handover request to each of the one or more candidate BSs identifying the MS and the group preference information for each of the one or more candidate BSs, and receiving a handover response from each of the one or more candidate BSs including one or more of the followings: the group assignment for the MS, a group boundary information, a modulation and coding scheme (MCS) for the assigned group's MAP, and a ranging opportunity for the assigned group. Also, the sending operation 630 may include sending by the serving BS to the MS, for each of the one or more candidate BSs, one of the followings: the group assignment for the MS, the group boundary information, the modulation and coding scheme (MCS) for the assigned group's MAP, and the ranging opportunity for the assigned group.

In the flow chart of FIG. 6, the Map DCIs provided by the MS may be determined based on the MS performing one or more of the following for each of the one or more candidate BSs, for example: acquiring a signal from a candidate BS; demodulating an acquired signal from a candidate BS; performing a forward error correction; performing a CRC (cyclic redundancy check) check on a packet received from a candidate BS; measuring a channel quality of a signal received from a candidate BS; or measuring a channel quality of one or more group Maps received from a candidate BS.

The flow chart illustrated in FIG. 6 may include additional operations, including, after or during a handover of the MS from the serving BS to the selected candidate BS, the MS performing data exchange with the selected candidate BS and also performing ranging, via the ranging opportunity provided from the selected candidate BS with the selected candidate BS.

The receiving operation 610 may include at least one of: receiving at the serving BS from the MS, a mobile scanning or measurement report of neighboring BSs, either periodically or event triggered or upon request by the serving BS, the mobile scanning or measurement report including at least a Map decode capability indication (Map DCI) for each of one or more group Maps, the mobile scanning report including at least the Map decode capability indication (Map DCI) for each of one or more group Maps including a group 1 Map and/or a group 2 Map, the Map DCI(s) being provided with respect to each of the one or more candidate base stations (BSs); or, receiving at the serving BS from the MS, a mobile station handover request from the MS including a Map decode capability indication (Map DCI) for each of one or more group Maps including a group 1 Map and/or a group 2 Map, the one or more Map DCIs being provided with respect to each of the one or more candidate base stations (BSs).

The sending operation 630 may include at least one of: sending by the serving BS to the MS a base station handover response including the group assignment from each of the candidate BSs; or sending by the serving BS to the MS a base station handover request including the group assignment from each of the candidate BSs.

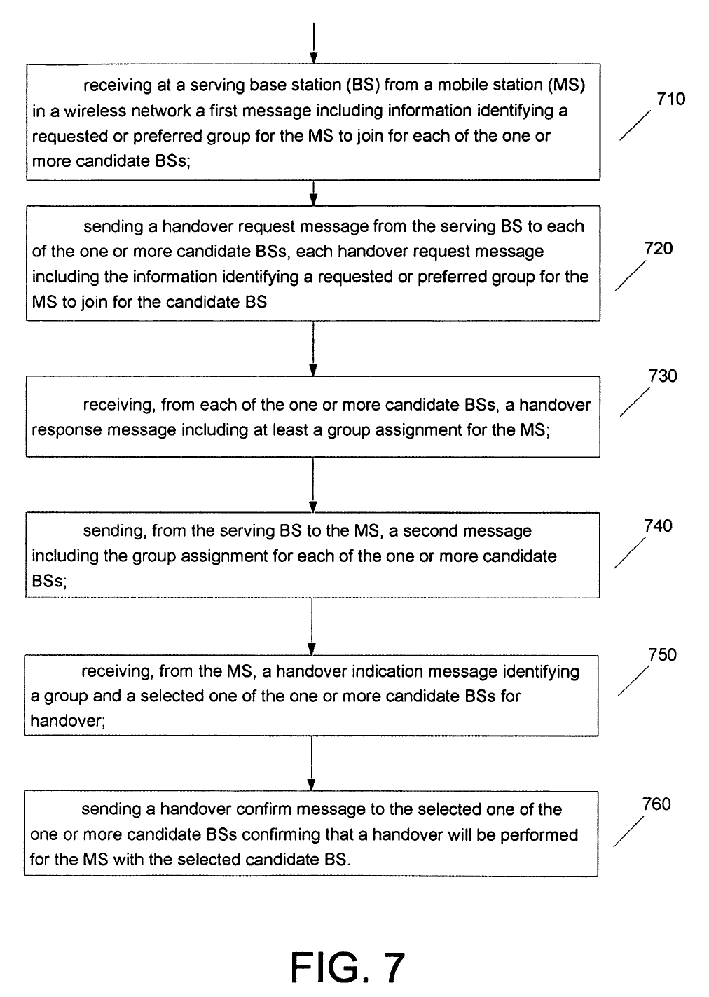

FIG. 7 is flow chart illustrating operation of a serving base station according to another example embodiment.

Receiving operation 710 may include receiving at a serving base station (BS) from a mobile station (MS) in a wireless network a first message including information identifying a requested or preferred group for the MS to join for each of the one or more candidate BSs.

Sending operation 720 may include sending a handover request message from the serving BS to each of the one or more candidate BSs, each handover request message including the information identifying a requested or preferred group for the MS to join for the candidate BS.

Receiving operation 730 may include receiving, from each of the one or more candidate BSs, a handover response message including at least a group assignment for the MS.

Sending operation 740 may include sending, from the serving BS to the MS, a second message including the group assignment for each of the one or more candidate BSs.

Receiving operation 750 may include receiving, from the MS, a handover indication message identifying a group and a selected one of the one or more candidate BSs for handover.

Sending operation 760 may include sending a handover confirm message to the selected one of the one or more candidate BSs confirming that a handover will be performed for the MS with the selected candidate BS.

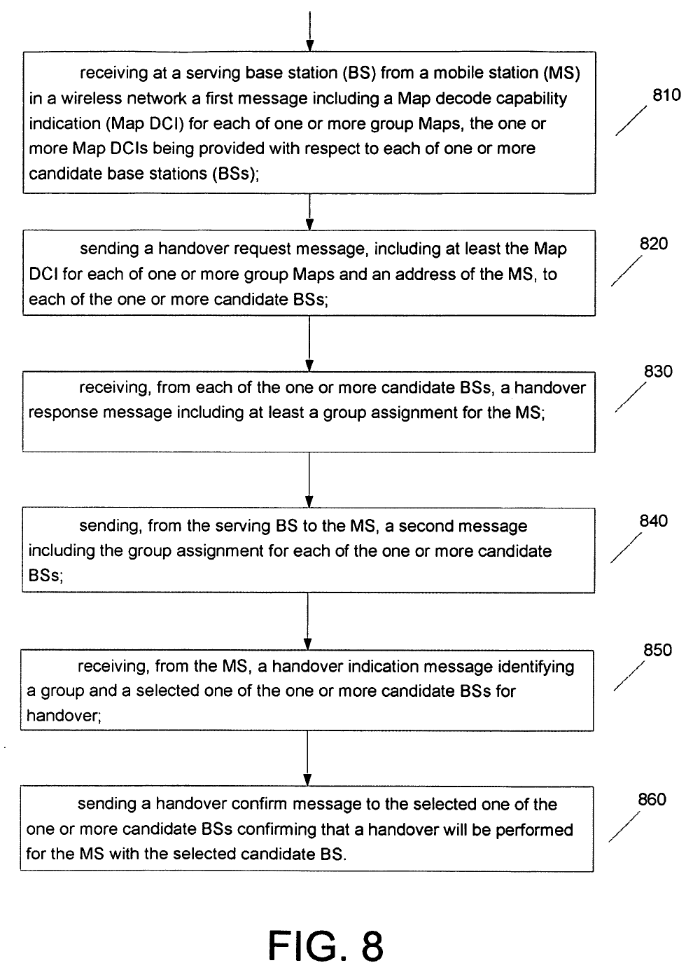

FIG. 8 is flow chart illustrating operation of a serving base station according to yet another example embodiment.

Receiving operation 810 may include receiving at a serving base station (BS) from a mobile station (MS) in a wireless network a first message including a Map decode capability indication (Map DCI) for each of one or more group Maps, the one or more Map DCIs being provided with respect to each of one or more candidate base stations (BSs).

Sending operation 820 may include sending a handover request message, including at least the Map DCI for each of one or more group Maps and an address of the MS, to each of the one or more candidate BSs.

Receiving operation 830 may include receiving, from each of the one or more candidate BSs, a handover response message including at least a group assignment for the MS.

Sending operation 840 may include sending, from the serving BS to the MS, a second message including the group assignment for each of the one or more candidate BSs.

Receiving operation 850 may include receiving, from the MS, a handover indication message identifying a group and a selected one of the one or more candidate BSs for handover.

Sending operation 860 may include sending a handover confirm message to the selected one of the one or more candidate BSs confirming that a handover will be performed for the MS with the selected candidate BS. Various alternative embodiments will now be described for the flow chart illustrated in FIG. 8.

The receiving operation 810 may include receiving at the serving base station (BS) from the mobile station (MS) in the wireless network the first message also including a preferred group indication (PGI) for one or more of the candidate BSs, the PGI identifying a preferred group of the MS to join of the candidate BS.

In the flow chart of FIG. 8, the preferred group(s) identified by the PGI for one or more of the candidate BSs may be selected as preferred by the MS based on one or more of: the Map DCI for the candidate BS, a modulation and coding scheme (MCS) used by the candidate BS for the preferred group, or a received signal strength, a carrier to interference and noise ratio and/or other channel quality indication for the group signals from the candidate BS as received by the MS.

The receiving operation 810 may include receiving, at the serving BS from the MS, a mobile scanning (or measurement) report of neighboring BSs, either periodically or event triggered or upon request by the serving BS, the mobile scanning report including at least the Map decode capability indication (Map DCI) for each of one or more group Maps including a group 1 Map and/or a group 2 Map. Also, the sending operation 840 may include sending, from the serving BS to the MS, a base station handover request message including the group assignment for each of the one or more candidate BSs.

The receiving operation 810 may include receiving, at the serving BS from the MS, a mobile station handover request including at least the Map decode capability indication (Map DCI) for each of one or more group Maps including a group 1 Map and/or a group 2 Map. Also, the sending operation 840 may include sending, from the serving BS to the MS, a base station handover request message including the group assignment for each of the one or more candidate BSs.

In the flow chart of FIG. 8, the Map DCIs provided by the MS may be determined based on the MS performing scanning on the one or more candidate BSs and determining whether the MS is capable of decoding one or more group Maps for one or more of the candidate BSs. As noted, this decode capability may be an estimate or may be an indication that the MS is likely or unlikely to be able to decode a particular group Map, for example.

The receiving operation 830 may include receiving, from each of the one or more candidate BSs, a handover response message including at least a group assignment for the MS, group boundary information, and an identification of ranging resources to be used for ranging.

In the flow chart illustrated in FIG. 8, in an example embodiment at least the handover response message from the selected candidate BS includes a group assignment for the MS and an identification of ranging resources to be used for ranging with the selected candidate BS after handover of the MS from the serving BS to the selected candidate BS.

The receiving operation 830 may include receiving, from each of the one or more candidate BSs, the handover response message including at least the group assignment for the MS and a group boundary information identifying a group boundary for one or more frames to be transmitted by the candidate BS.

According to an example embodiment, an apparatus may include a controller, and a wireless transceiver. The apparatus may, for example, be configured to receive at a serving base station (BS) from a mobile station (MS) in a wireless network a first message including a Map decode capability indication (Map DCI) for each of one or more group Maps, the one or more Map DCIs being provided with respect to each of one or more candidate base stations (BSs); send a handover request message, including at least the Map DCI for each of one or more group Maps and an address of the MS, to each of the one or more candidate BSs; receive, from each of the one or more candidate BSs, a handover response message including at least a group assignment for the MS; send, from the serving BS to the MS, a second message including the group assignment for each of the one or more candidate BSs; receive, from the MS, a handover indication message identifying a group and a selected one of the one or more candidate BSs for handover; and send a handover confirm message to the selected one of the one or more candidate BSs confirming that a handover will be performed for the MS with the selected candidate BS.

In an example embodiment, the apparatus being configured to receive, from each of the one or more candidate BSs, the handover response message may include the wireless transceiver being configured to receive, from each of the one or more candidate BSs, the handover response message including at least the group assignment for the MS and a group boundary information identifying a group boundary for one or more frames to be transmitted by the candidate BS.

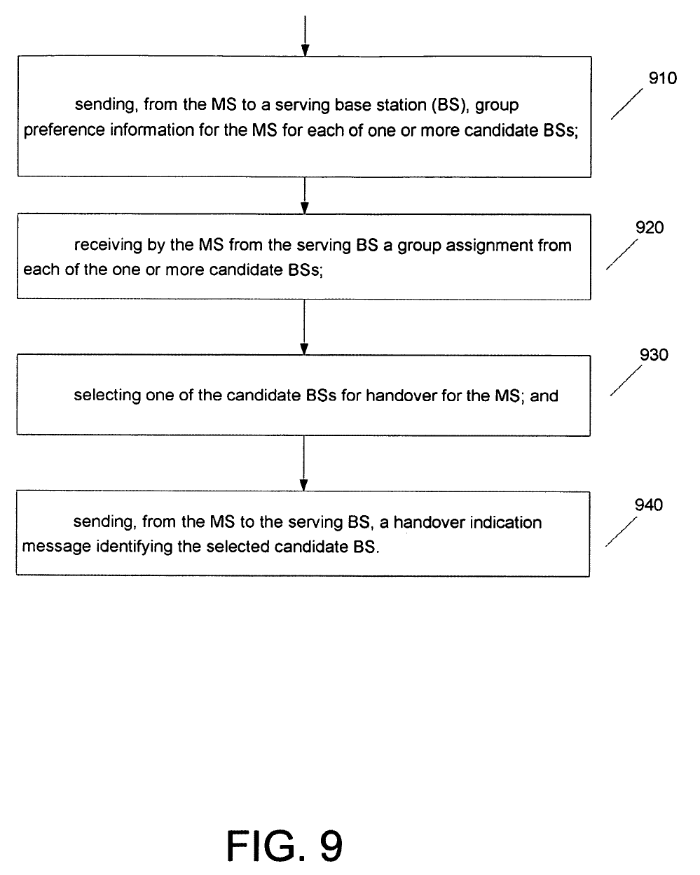

FIG. 9 is flow chart illustrating operation of a mobile station according to an example embodiment.

Sending operation 910 may include sending, from the MS to a serving base station (BS), group preference information for the MS for each of one or more candidate BSs.

Receiving operation 920 may include receiving by the MS from the serving BS a group assignment from each of the one or more candidate BSs.

Selecting operation 930 may include selecting one of the candidate BSs for handover for the MS.

Sending operation 940 may include sending, from the MS to the serving BS, a handover indication message identifying the selected candidate BS. Various alternative embodiments will now be described with reference to FIG. 9.

The receiving operation 920 may include receiving by the MS from the serving BS a group assignment and a ranging opportunity for the assigned group from each of the candidate BSs, including receiving a ranging opportunity for the assigned group from the selected candidate BS, and

The method illustrated in the flow chart of FIG. 9 may further include, after a handover of the MS from the serving BS to the selected candidate BS, the MS performing ranging via the ranging opportunity received from the selected candidate BS.

The receiving operation 920 may include receiving by the MS from the serving BS, for each of the one or more candidate BSs, a group assignment, a ranging opportunity for the assigned group, a group boundary information, a modulation and coding scheme (MCS) for the assigned group, and a ranging opportunity for the assigned group.

The sending operation 910 may include: determining, by the MS, a preferred group for each of the one or more candidate BSs, based on one or more of: a modulation and coding scheme (MCS) used by the candidate BS for each group Map of the BS, a received signal strength, a carrier to interference and noise ratio and/or other channel quality indication for signals of a group from the candidate BS as received by the MS; and sending, from the MS to a serving BS, a preferred group indication (PGI) for one or more of the candidate BSs, the PGI identifying at least one of group 1 or group 2 as a preferred group of the MS to join of the candidate BS. Various alternatives of the flow chart illustrated in FIG. 9 will be described.

The sending operation 910 may include performing ranging with one or more of the candidate BSs to negotiate a group of each candidate that the MS may join; sending, from the MS to a serving BS, a preferred group indication (PGI) for one or more of the candidate BSs, the PGI identifying at least one of group 1 or group 2 of the MS to join of the candidate BS, as negotiated between the MS and each of the one or more candidate BSs.

The sending operation 910 may include performing scanning on the one or more candidate BSs and determining whether the MS is capable of decoding one or more group Maps transmitted from each of the one or more of the candidate BSs; and performing ranging with one or more of the candidate BSs, including sending a range request message including a Map decode capability indication (Map DCI) indicating that the MS can decode a group Map for one or more of the candidate BSs and receiving a range response message from each of the one or more candidate BSs indicating whether the MS may join the group for which the MS can decode the group Map.

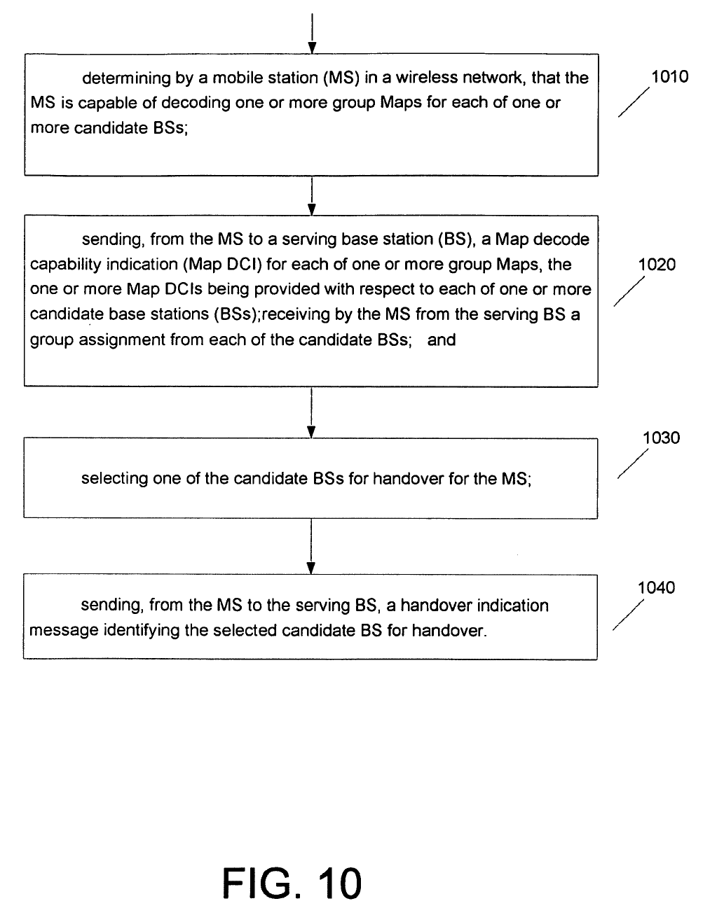

FIG. 10 is flow chart illustrating operation of a mobile station according to another example embodiment.

Determining operation 1010 may include determining by a mobile station (MS) in a wireless network, that the MS is capable of decoding one or more group Maps for each of one or more candidate BSs.

Sending operation 1020 may include sending, from the MS to a serving base station (BS), a Map decode capability indication (Map DCI) for each of one or more group Maps, the one or more Map DCIs being provided with respect to each of one or more candidate base stations (BSs); receiving by the MS from the serving BS a group assignment from each of the candidate BSs.

Selecting operation 1030 may include the MS selecting one of the candidate BSs for handover for the MS.

Sending operation 1040 may include sending, from the MS to the serving BS, a handover indication message identifying the selected candidate BS for handover.

Determining operation 1010 may include performing, by a mobile station (MS) in a wireless network, scanning and obtaining the ability to decode including attempting to decode one or more group Maps for each of the one or more candidate BSs. In another example embodiment, determining operation 1010 may include performing one or more of the following for each of the one or more candidate BSs: acquiring a signal from a candidate BS; demodulating an acquired signal from a candidate BS; performing a forward error correction; performing a CRC (cyclic redundancy check) check on a packet received from a candidate BS; measuring a channel quality of a signal received from a candidate BS; or measuring a channel quality of one or more group Maps received from a candidate BS.

The determining operation 1010 may also include performing ranging with each of the one or more candidate BSs.

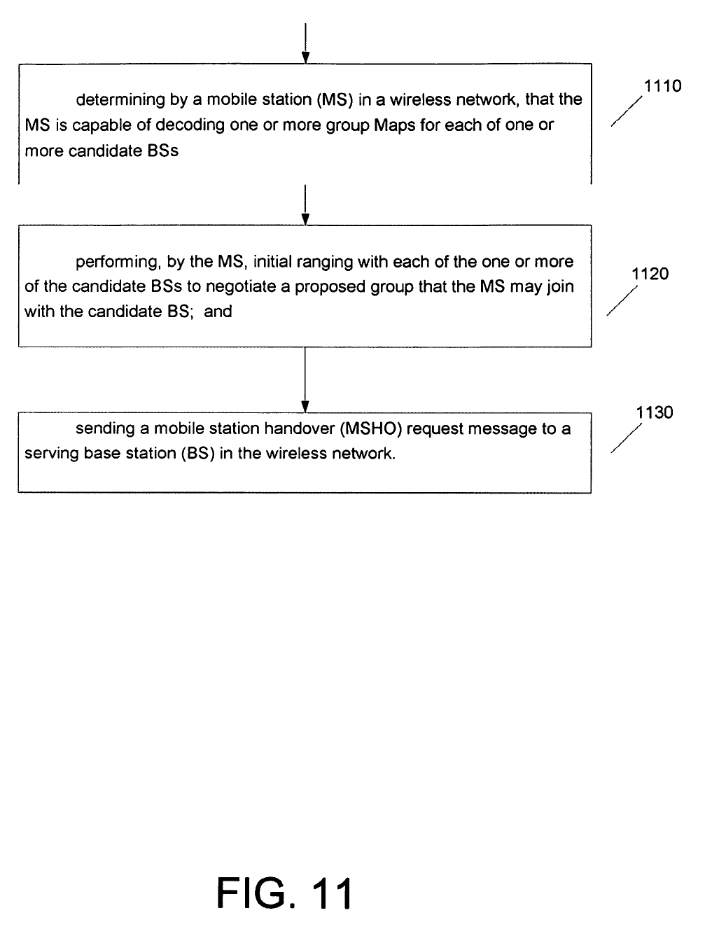

FIG. 11 is flow chart illustrating operation of a mobile station according to another example embodiment. Determining operation 1110 may include determining by a mobile station (MS) in a wireless network, that the MS is capable of decoding one or more group Maps for each of one or more candidate BSs.

In an example embodiment, the determining operation 1110 may include performing one or more of the following for each of the one or more candidate BSs: acquiring a signal from a candidate BS; demodulating an acquired signal from a candidate BS; performing a forward error correction; performing a CRC (cyclic redundancy check) check on a packet received from a candidate BS; measuring a channel quality of a signal received from a candidate BS; or measuring a channel quality of one or more group Maps received from a candidate BS.

Performing operation 1120 may include performing, by the MS, ranging with each of the one or more of the candidate BSs, for which the MS is capable of decoding a group Map, e.g., to negotiate a proposed group that the MS may join with the candidate BS.

Sending operation 1130 may include sending a mobile station handover (MSHO) request message to a serving base station (BS) in the wireless network. Various alternatives for FIG. 11 will now be described.

The method or flow chart illustrated in FIG. 11 may further include the operations: receiving, at the MS from the serving BS, a base station handover (BSHO) response message, selecting one of the candidate BSs for handover; sending, from the MS to the serving BS, a handover indication message including an identification of a selected candidate BS and the proposed group, as negotiated, for the selected candidate BS; and performing network entry or re-entry at the selected candidate BS.

The sending operation 1130 may include sending a mobile station handover (MSHO) request message to the serving base station (BS), the MSHO request message identifying the proposed group for each of the one or more candidate BSs.

The performing operation 1120 may include performing by the MS, with each of the one or more candidate BSs, ranging via at least one of more groups including either a group 1 ranging region or a group 2 ranging region.

The determining operation 1110 may include decoding a group 1 Map for a first candidate BS, and unsuccessfully attempting to decode a group 2 Map for the first candidate BS, and wherein the performing comprises the MS performing ranging with the first candidate BS via a group 1 ranging region (or group 1 ranging resources).

In an example embodiment of the flow chart of FIG. 11, the MS may indicate that the first group is a preferred group to join by performing ranging via a first group region (or first group ranging region) with the first candidate BS.

In an example embodiment of the flow chart of FIG. 11, as part of performing the ranging with the first candidate BS, the MS may indicate that the MS is able to decode group 1 Map and is unable to decode the group 2 Map transmitted by the first candidate BS.

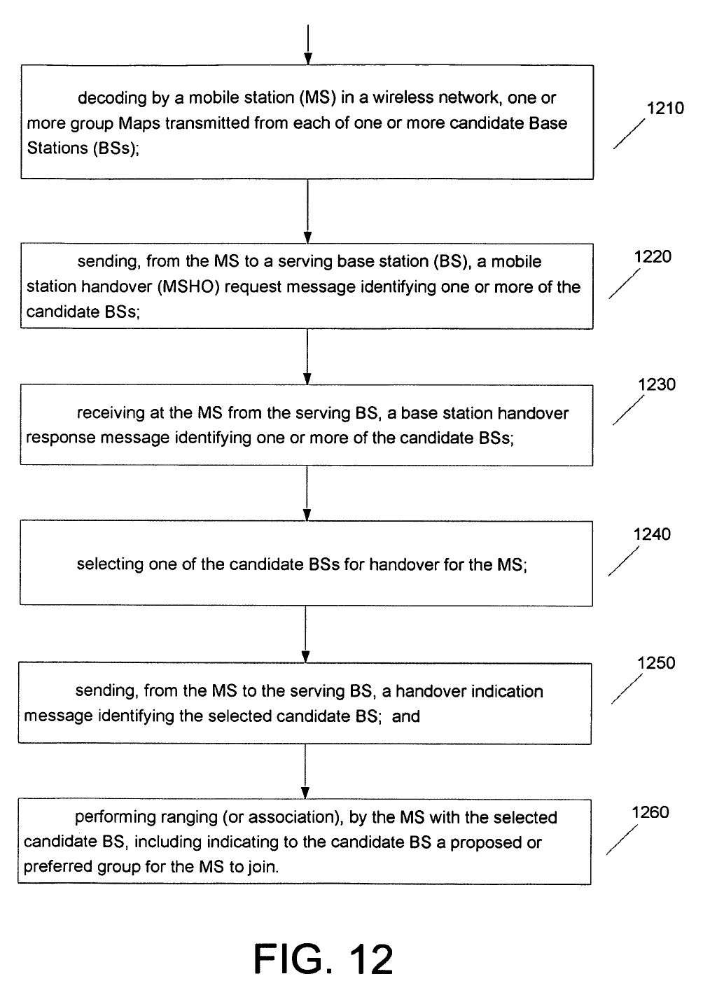

FIG. 12 is a flow chart illustrating operation of a mobile station according to yet another example embodiment.

Decoding operation 1210 may include decoding by a mobile station (MS) in a wireless network, one or more group Maps transmitted from each of one or more candidate Base Stations (BSs).

Sending operation 1220 may include sending, from the MS to a serving base station (BS), a mobile station handover (MSHO) request message identifying one or more of the candidate BSs.

Receiving operation 1230 may include receiving at the MS from the serving BS, a base station handover response message identifying one or more of the candidate BSs.

Selecting operation 1240 may include selecting one of the candidate BSs for handover for the MS.

Sending operation 1250 may include sending, from the MS to the serving BS, a handover indication message identifying the selected candidate BS.

And, performing operation 1260 may include performing ranging (or association), by the MS with the selected candidate BS, including indicating to the candidate BS a proposed or preferred group for the MS to join.

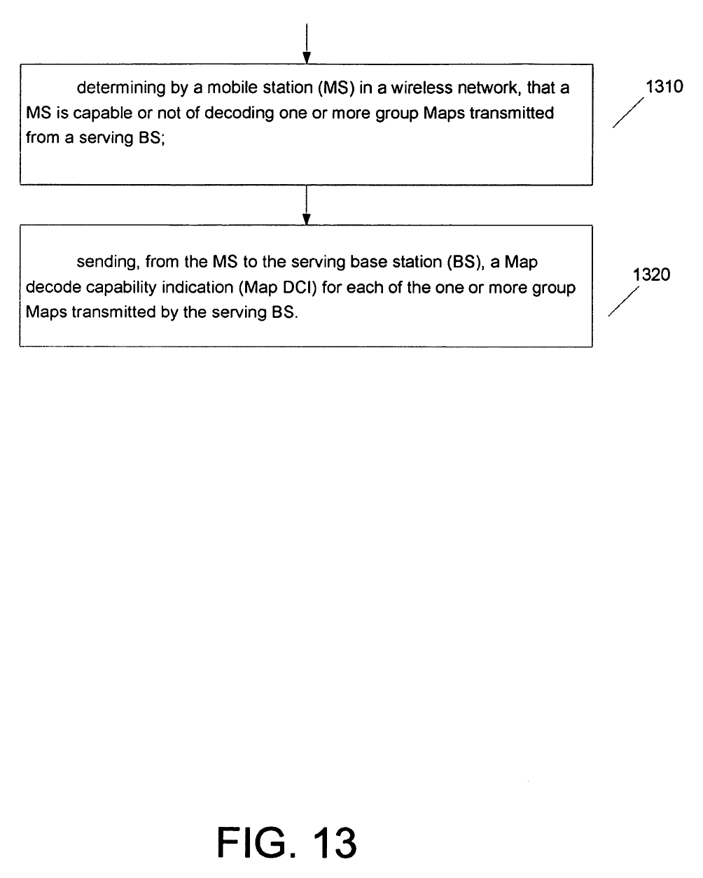

FIG. 13 is a flow chart illustrating operation of a mobile station according to yet another example embodiment. Determining operation 1310 may include determining by a mobile station (MS) in a wireless network, that a MS is capable or not of decoding one or more group Maps transmitted from a serving BS. Sending operation 1320 may include sending, from the MS to the serving base station (BS), a Map decode capability indication (Map DCI) for each of the one or more group Maps transmitted by the serving BS.

The method illustrated in FIG. 13 may further include receiving an updated group assignment from the serving BS.

The determining operation 1310 may include performing one or more of the following: acquiring a signal from the serving BS; demodulating an acquired signal from the serving BS; performing a forward error correction; performing a CRC (cyclic redundancy check) check on a packet received from the serving BS; measuring a channel quality of a signal received from the serving BS; or measuring a channel quality of one or more group Maps received from the serving BS.

The method illustrated in FIG. 13 may further include determining by a mobile station (MS) in a wireless network, that the MS is capable of decoding one or more group Maps for each of one or more candidate BSs, and sending a report to the serving BS, the report including a Map decode capability indication (Map DCI) for each of the one or more group Maps transmitted by the serving BS and a Map DCI for each of the one or more candidate BSs.

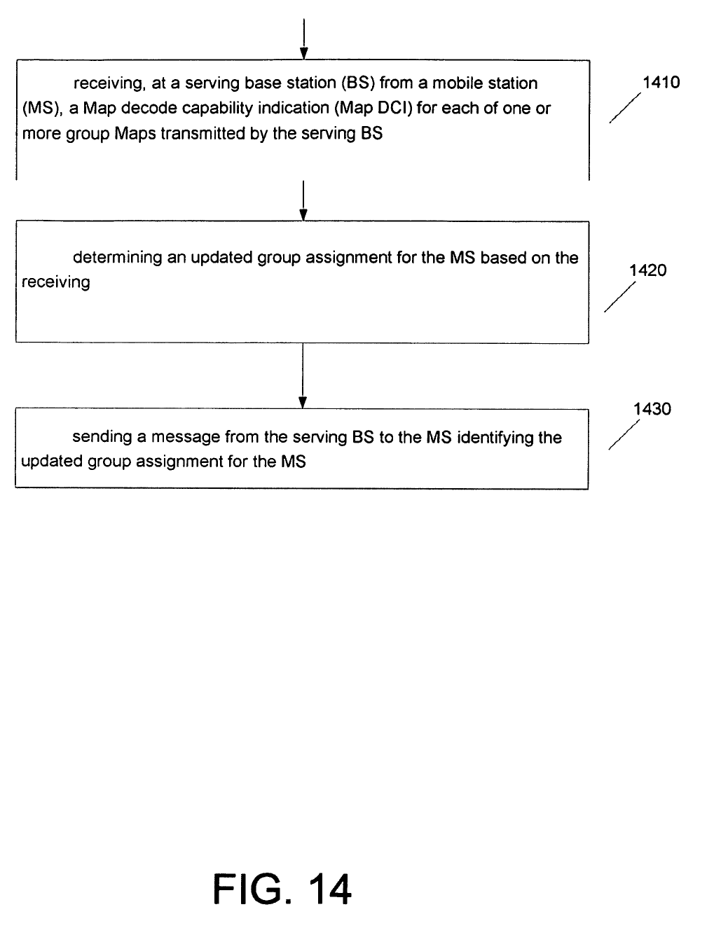

FIG. 14 is a flow chart illustrating operation of a base station according to yet another example embodiment. Receiving operation 1410 may include receiving, at a serving base station (BS) from a mobile station (MS), a Map decode capability indication (Map DCI) for each of one or more group Maps transmitted by the serving BS. Determining operation 1420 may include determining an updated group assignment for the MS based on the receiving. And, Sending operation 1430 may include sending a message from the serving BS to the MS identifying the updated group assignment for the MS.

For example, if a MS is currently assigned to group 2, and the MS moves slightly away from the serving BS, then the RSSI of the group 2 Map may decrease, and due to the MCS for the group 2 Map, the MS may be unable (or unlikely) to decode the group 2 Map. The MS may send a message to the serving BS to indicate that the MS can decode group 1 Map, but is unlikely to be able to decode group 2 Map (e.g., by providing Map DCI information). This is merely an example.

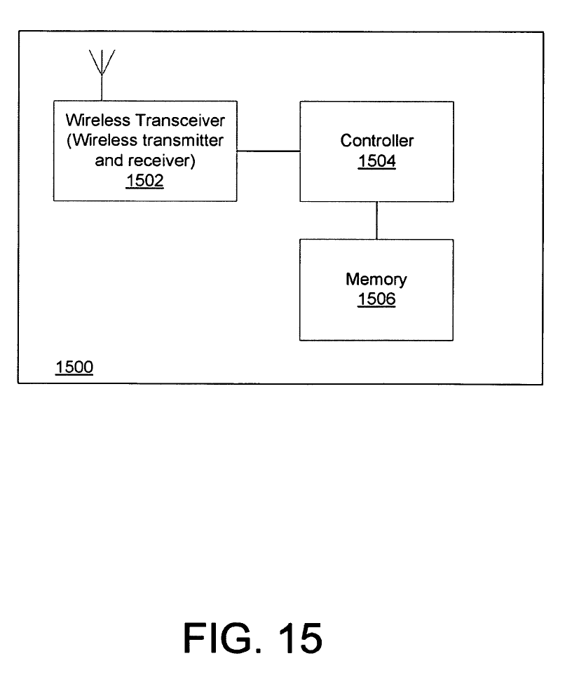

FIG. 15 is a block diagram of a wireless station (or wireless node) 1500 according to an example embodiment. The wireless station 1500 (e.g., base station 104 or mobile station 106) may include, for example, a wireless transceiver (or wireless interface) 1502, including a transmitter to transmit signals and a receiver to receive signals, a controller 1504 to control operation of the station and execute instructions or software, and a memory 1506 to store data and/or instructions. Controller 1504 may also make decisions or determinations, generate frames or messages for transmission, decode received frames or messages for further processing, and other tasks or functions described herein. Controller 1504 may be programmable and capable of executing software or other instructions stored in memory or on other computer media to perform the various tasks and functions described above, such as one or more of the tasks or methods described above.

In addition, a storage medium may be provided that includes stored instructions, which when executed by a controller or processor may result in the controller 1304, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. A method comprising:
receiving, at a serving base station (BS) in a wireless network from a mobile station (MS), group preference information for the MS for each of one or more candidate BSs;
obtaining, by the serving BS based on the group preference information, a group assignment for the MS from each of the one or more candidate BSs; and
sending, by the serving BS to the MS the group assignment from each of the candidate BSs.

2. The method of claim 1 and further comprising receiving, at the serving BS from the MS, a handover indication message identifying a selected candidate BS of the one or more candidate BSs for handover of the MS from the serving BS to the selected candidate BS.

3. The method of claim 1 wherein the obtaining comprises obtaining, by the serving BS based on the group preference information, the group assignment for the MS and a group boundary from each of the one or more candidate BSs; and
wherein the sending comprises sending by the serving BS to the MS the group assignment and the group boundary from each of the candidate BSs.

4. The method of claim 1 wherein the receiving, at the serving BS, group preference information for the MS for each of one or more candidate BSs comprises receiving from the MS a Map decode capability indication (Map DCI) for each of one or more group Maps, the one or more Map DCIs being provided with respect to each of one or more candidate base stations (BSs).

5. The method of claim 1 wherein the receiving, at the serving BS, group preference information for the MS for each of one or more candidate BSs comprises receiving from the MS a preferred group indication (PGI) for one or more of the candidate BSs, the PGI identifying at least one of a group 1 or a group 2 as a preferred group of the MS to join of the candidate BS.

6. The method of claim 1 wherein the obtaining comprises sending a handover request to each of the one or more candidate BSs identifying the MS and the group preference information for each of the one or more candidate BSs, and receiving a handover response from each of the one or more candidate BSs including the group assignment for the MS, a group boundary information, a modulation and coding scheme (MCS) for the assigned group, and a ranging opportunity for the assigned group; and
wherein the sending by the serving BS to the MS the group assignment from each of the candidate BSs comprises sending by the serving BS to the MS, for each of the one or more candidate BSs, the group assignment for the MS, the group boundary information, the modulation and coding scheme (MCS) for the assigned group, and the ranging opportunity for the assigned group.

7. The method of claim 6 and further comprising, during a handover of the MS from the serving BS to the selected candidate BS, the MS performing data exchange with the selected candidate BS and also performing ranging, via the ranging opportunity provided from the selected candidate BS with the selected candidate BS.

8. The method of claim 1 wherein the receiving, at the serving base station (BS), group preference information comprises at least one of:
receiving at the serving BS from the MS, a mobile scanning or measurement report of neighboring BSs, either periodically or event triggered or upon request by the serving BS, the mobile scanning or measurement report including at least a Map decode capability indication (Map DCI) for each of one or more group Maps, the mobile scanning report including at least the Map decode capability indication (Map DCI) for each of one or more group Maps including a group 1 Map and/or a group 2 Map, the Map DCI(s) being provided with respect to each of the one or more candidate base stations (BSs); or
receiving at the serving BS from the MS, a mobile station handover request from the MS including a Map decode capability indication (Map DCI) for each of one or more group Maps including a group 1 Map and/or a group 2 Map, the one or more Map DCIs being provided with respect to each of the one or more candidate base stations (BSs).

9. The method of claim 1 wherein the sending by the serving BS to the MS the group assignment from each of the candidate BSs comprises at least one of:
sending by the serving BS to the MS a mobile station handover response including the group assignment from each of the candidate BSs; or
sending by the serving BS to the MS a base station handover request including the group assignment from each of the candidate BSs.

10. A method comprising:
receiving at a serving base station (BS) from a mobile station (MS) in a wireless network a first message including information identifying a requested or preferred group for the MS to join for each of the one or more candidate BSs;
sending a handover request message from the serving BS to each of the one or more candidate BSs, each handover request message including the information identifying a requested or preferred group for the MS to join for the candidate BS;
receiving, from each of the one or more candidate BSs, a handover response message including at least a group assignment for the MS;
sending, from the serving BS to the MS, a second message including the group assignment for each of the one or more candidate BSs;
receiving, from the MS, a handover indication message identifying a group and a selected one of the one or more candidate BSs for handover;
sending a handover confirm message to the selected one of the one or more candidate BSs confirming that a handover will be performed for the MS with the selected candidate BS.

11. A method comprising:
receiving at a serving base station (BS) from a mobile station (MS) in a wireless network a first message including a Map decode capability indication (Map DCI) for each of one or more group Maps, the one or more Map DCIs being provided with respect to each of one or more candidate base stations (BSs);
sending a handover request message, including at least the Map DCI for each of one or more group Maps and an address of the MS, to each of the one or more candidate BSs;
receiving, from each of the one or more candidate BSs, a handover response message including at least a group assignment for the MS;
sending, from the serving BS to the MS, a second message including the group assignment for each of the one or more candidate BSs;
receiving, from the MS, a handover indication message identifying a group and a selected one of the one or more candidate BSs for handover;
sending a handover confirm message to the selected one of the one or more candidate BSs confirming that a handover will be performed for the MS with the selected candidate BS.

12. The method of claim 11 wherein the receiving at a serving base station (BS) from a mobile station (MS) in a wireless network the first message comprises receiving at the serving base station (BS) from the mobile station (MS) in the wireless network the first message also including a preferred group indication (PGI) for one or more of the candidate BSs, the PGI identifying a preferred group of the MS to join of the candidate BS.

13. The method of claim 12 wherein each of the preferred group(s) identified by the PGI for one or more of the candidate BSs are selected as preferred by the MS based on one or more of: the Map DCI for the candidate BS, a modulation and coding scheme (MCS) used by the candidate BS for the preferred group, or a received signal strength, a carrier to interference and noise ratio and/or other channel quality indication for the group signals from the candidate BS as received by the MS.

14. The method of claim 11 wherein:
the receiving at a serving base station (BS) from a mobile station (MS) in a wireless network a first message comprises receiving, at the serving BS from the MS, a mobile scanning (or measurement) report of neighboring BSs, either periodically or event triggered or upon request by the serving BS, the mobile scanning report including at least the Map decode capability indication (Map DCI) for each of one or more group Maps including a group 1 Map and/or a group 2 Map; and
wherein, the sending a second message comprises sending, from the serving BS to the MS, a base station handover request message including the group assignment for each of the one or more candidate BSs.

15. The method of claim 11 wherein:
the receiving at a serving base station (BS) from a mobile station (MS) in a wireless network a first message comprises receiving, at the serving BS from the MS, a mobile station handover request including at least the Map decode capability indication (Map DCI) for each of one or more group Maps including a group 1 Map and/or a group 2 Map; and
wherein, the sending a second message comprises sending, from the serving BS to the MS, a base station handover request message including the group assignment for each of the one or more candidate BSs.

16. The method of claim 11 wherein the Map DCIs provided by the MS are determined based on the MS performing one or more of the following for each of the one or more candidate BSs:
acquiring a signal from a candidate BS;
demodulating an acquired signal from a candidate BS;
performing a forward error correction;
performing a CRC (cyclic redundancy check) check on a packet received from a candidate BS;
measuring a channel quality of a signal received from a candidate BS; or
measuring a channel quality of one or more group Maps received from a candidate BS.

17. The method of claim 11 wherein the receiving, from each of the one or more candidate BSs, a handover response message comprises receiving, from each of the one or more candidate BSs, a handover response message including at least a group assignment for the MS, group boundary information, and an identification of ranging resources to be used for ranging.

18. The method of claim 11 wherein at least the handover response message from the selected candidate BS includes a group assignment for the MS and an identification of ranging resources to be used for ranging with the selected candidate BS after handover of the MS from the serving BS to the selected candidate BS.

19. The method of claim 11 wherein the receiving, from each of the one or more candidate BSs, the handover response message comprises receiving, from each of the one or more candidate BSs, the handover response message including at least the group assignment for the MS and a group boundary information identifying a group boundary for one or more frames to be transmitted by the candidate BS.

20-39. (canceled)

40. A method comprising:
determining by a mobile station (MS) in a wireless network, that a MS is capable or not of decoding one or more group Maps transmitted from a serving BS;
sending, from the MS to the serving base station (BS), a Map decode capability indication (Map DCI) for each of the one or more group Maps transmitted by the serving BS.

41. The method of claim 40 and further comprising receiving an updated group assignment from the serving BS.

42. The method of claim 40 wherein the determining comprises performing one or more of the following:
acquiring a signal from the serving BS;
demodulating an acquired signal from the serving BS;
performing a forward error correction;
performing a CRC (cyclic redundancy check) check on a packet received from the serving BS;
measuring a channel quality of a signal received from the serving BS; or
measuring a channel quality of one or more group Maps received from the serving BS.

43. The method of claim 40 and further comprising:
determining by a mobile station (MS) in a wireless network, that the MS is capable of decoding one or more group Maps for each of one or more candidate BSs; and
sending a report to the serving BS, the report including a Map decode capability indication (Map DCI) for each of the one or more group Maps transmitted by the serving BS and a Map DCI for each of the one or more candidate BSs.

44. A method comprising:
receiving, at a serving base station (BS) from a mobile station (MS), a Map decode capability indication (Map DCI) for each of one or more group Maps transmitted by the serving BS;
determining an updated group assignment for the MS based on the receiving; and
sending a message from the serving BS to the MS identifying the updated group assignment for the MS.
